(19) United States
(12) Patent Application Publication
(10) Pub. No.: US 2018/0028944 A1
(43) Pub. Date: Feb. 1, 2018

(54) WATER PROCESSING SYSTEM

(71) Applicant: NUBENT PTY LTD, Gerringong (AU)

(72) Inventor: John Martin BRADLEY, Gerringong (AU)

(73) Assignee: NUBENT PTY LTD, Gerringong (AU)

(21) Appl. No.: 15/714,939

(22) Filed: Sep. 25, 2017

Related U.S. Application Data
(63) Continuation-in-part of application No. PCT/AU2015/050132, filed on Mar. 25, 2015.

(30) Foreign Application Priority Data
Oct. 1, 2016 (AU) 2016235031

(51) Int. Cl. B01D 21/28; C02F 9/00; B01F 15/00; B01D 21/30; C02F 1/00; B01F 7/00; C02F 1/52; B01D 21/01

(52) U.S. Cl. CPC B01D 21/286; C02F 1/5236; C02F 1/5281; C02F 9/00; B01D 21/01; B01D 21/30; C02F 1/008; B01F 7/002; B01F 7/0025; B01F 15/00448; C02F 2001/007; C02F 1/004; C02F 2303/04; B01F 2215/0052

(57) ABSTRACT

Disclosed herein is a water treatment system. The system comprises a mixing station in which coagulant is mixed into water for treatment in the system. The system comprises a floccule accumulation station in which the building of floccules in the water/coagulant mixture is promoted. The system comprises a settlement station in which the floccules are allowed to settle. The mixing station, floccule accumulation station and settlement station comprise one or more reservoirs, wherein at least one of the one or more reservoirs is an intermediate bulk container.

### CROSS-REFERENCE TO RELATED APPLICATIONS

This application is a continuation-in-part of International Patent Application No. PCT/AU2015/050132, filed Mar. 25, 2015 and claims priority to Australian Patent Application No. 2016235031, filed Oct. 1, 2016, the disclosures of which are incorporated herein by reference.

### TECHNICAL FIELD

The present disclosure relates to a water processing system. The system has been developed primarily for use in agricultural applications, and will be described hereinafter with reference to that application. However, it will be appreciated that the system may also be used in other applications, such as in small communities, remote locations, in emergency situations, and in other circumstances, particularly where a relatively low capital cost and quickly commissionable water treatment system is required.

### BACKGROUND

Known water treatment systems typically include a mixing station in which a flocculating agent is mixed with water undergoing treatment. The output from the mixing station is fed to a very large capacity settling tank, which is often formed from concrete or steel, in which floccules of contaminant from the water are allowed to settle whilst relatively clear water is removed from the top of the settling tank.

A disadvantage of known water treatment systems is their relatively high capital cost. Another problem is that they are not readily able to be scaled up or down in capacity if the quantity of water requiring treatment increases or declines. A further problem with known water treatment systems is that they can be very difficult to install in remote locations.

### SUMMARY

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Throughout this specification the word “intermediate bulk container” or “IBC”, will be understood to also encompass those containers referred to as a “plastic tote” or “bulky box”. Such containers are available in abundance, being commonly used to transport a large variety of materials, especially bulk quantities of liquids.

In a first aspect, there is provided a water treatment system comprising:

a mixing station comprising:
a first reservoir for receiving water for treatment,
an agitator in the first reservoir for mixing coagulant into the water; and

a settlement station downstream of the mixing station for receiving water output from the mixing station, the settlement station comprising a plurality of intermediate bulk containers in which contaminants from the water output from the mixing station are allowed to settle.

The settlement station may comprise a first plurality of intermediate bulk containers hydraulically connected together in series. The first plurality of intermediate bulk containers may comprise three or more intermediate bulk containers. The settlement station may comprise a second plurality of intermediate bulk containers hydraulically connected together in series and in which water output from the mixing station is allowed to settle, the second plurality of intermediate bulk containers being in parallel to the first plurality of intermediate bulk containers. The second plurality of intermediate bulk containers may comprise three or more intermediate bulk containers.

A floccule accumulation station may be provided between the mixing station and the settlement station to receive output from the mixing station and to discharge into the settlement station. The floccule accumulation station may comprise a second reservoir and a slow speed stirrer extending into the second reservoir, the stirrer being configured to promote building of floccules. The slow speed stirrer may rotate at a speed less than that of the agitator in the first reservoir. The slow speed stirrer may rotate at between 1 and 100 revolutions per minute depending on the geometry of the stirrer and the capacity of the second reservoir. The second reservoir may be an intermediate bulk container. The floccule accumulation station may comprise two or more of the second reservoirs, each having an associated slow speed stirrer.

The mixing station may be detachable from the settlement station and may be mounted on a vehicle to facilitate its deployment at various sites. The vehicle may be a powered vehicle, such as a utility truck, or may be an unpowered vehicle, such as a towable trailer. The floccule accumulation station may also be detachable from the settlement station and mounted on the vehicle. The vehicle may include a power source for powering the agitator(s) and/or stirrer(s) of the water treatment system. In other embodiments, the water treatment system is transportable altogether.

The agitator in the first reservoir may rotate at between 1000 and 3000 revolutions per minute depending on the geometry of the agitator and the capacity of the first reservoir.

A water pump may be associated with the mixing station for pumping water for treatment into the first reservoir.

A coagulant dosing pump may be associated with the mixing station for injecting coagulant into the first reservoir. The coagulant may comprise, for example, alum, ferric chloride or aluminium chlorohydrate.

A filtration station may be provided at the downstream end of the system. The filtration station may comprise a granular filter, such as a sand, zeolite or diatomaceous earth filter, or a paper-type cartridge filter.

A disinfectant dosing pump may be provided to inject disinfectant into water output from the downstream end of the settlement station. The disinfectant may comprise, for example, chlorine, sodium hypochlorite or hydrogen peroxide and/or silver ion. A reservoir for relatively clear water may be connected to a downstream end of the settlement station for receiving output therefrom and the disinfectant may be injected into this reservoir.

A water pump may be provided to pump water output from the downstream end of the settlement station to a large storage reservoir.

In a second aspect, there is provided a water treatment system comprising:

a mixing station comprising:
a first reservoir for receiving water for treatment,
an agitator in the first reservoir for mixing coagulant into the water; and

a settlement station downstream of the mixing station comprising at least one settling reservoir in which contaminants from the water output from the mixing station are allowed to settle,

wherein the mixing station is detachable from the settlement station and mounted on a vehicle to facilitate its deployment at various sites.

The at least one settling reservoir may comprise a first plurality of intermediate bulk containers hydraulically connected together in series, and contaminants in the water may be allowed to settle in the intermediate bulk containers in a clarifying sequence. The settlement station may comprise a second plurality of intermediate bulk containers hydraulically connected together in series, the second plurality of intermediate bulk containers being in parallel to the first plurality of intermediate bulk containers, such that contaminants in the water are allowed to settle in each branch of the intermediate bulk containers in a clarifying sequence. The first plurality of intermediate bulk containers may comprise three or more intermediate bulk containers. The second plurality of intermediate bulk containers may comprise three or more intermediate bulk containers.

A floccule accumulation station may be hydraulically connected to the mixing station for receiving output therefrom. The floccule accumulation station may comprise a second reservoir and a slow speed stirrer extending into the second reservoir, the stirrer being configured to promote building of floccules. The slow speed stirrer may rotate at a speed less than that of the agitator in the first reservoir. The slow speed stirrer may rotate at between 1 and 100 revolutions per minute depending on the geometry of the stirrer and the capacity of the second reservoir. The second reservoir may be an intermediate bulk container. The floccule accumulation station may comprise two or more of the second reservoirs, each having an associated slow speed stirrer.

The vehicle may be a powered vehicle, such as a utility truck, or may be an unpowered vehicle, such as a towable trailer. The vehicle may include a power source for powering the agitator(s) and/or stirrer(s) of the water treatment system.

The agitator in the first reservoir may rotate at between 1000 and 3000 revolutions per minute depending on the geometry of the agitator and the capacity of the first reservoir.

A water pump may be associated with the mixing station for pumping water for treatment into the first reservoir.

A coagulant dosing pump may be associated with the mixing station for injecting coagulant into the first reservoir. The coagulant may comprise, for example alum, ferric chloride or aluminium chlorohydrate.

A filtration station may be provided at the downstream end of the system. The filtration station may comprise a granular filter, such as a sand, zeolite or diatomaceous earth filter, or a paper-type cartridge filter.

A disinfectant dosing pump may be provided to inject disinfectant into water output from the downstream end of the settlement station. The disinfectant may comprise, for example, chlorine, sodium hypochlorite or hydrogen peroxide and or silver ion. A reservoir for relatively clear water may be connected to a downstream end of the settlement station for receiving output therefrom and the disinfectant may be injected into this reservoir.

A water pump may be provided to pump water output from the downstream end of the settlement station to a large storage reservoir.

In a third aspect, there is provided a water treatment method, comprising:

directing water for treatment into a mixing station;

mixing coagulant into the water in the mixing station; and

discharging the water from the mixing station to a settlement station comprising a plurality of intermediate bulk containers and allowing contaminants in the water to settle in the intermediate bulk containers.

The settlement station may comprise a first plurality of intermediate bulk containers hydraulically connected together in series and in which contaminants in the water are allowed to settle in a clarifying sequence. The first plurality of intermediate bulk containers may comprise three or more intermediate bulk containers. The settlement station may comprise a second plurality of intermediate bulk containers hydraulically connected together in series, the second plurality of intermediate bulk containers being in parallel to the first plurality of intermediate bulk containers, such that contaminants in the water are allowed to settle in each branch of the intermediate bulk containers in a clarifying sequence. The second plurality of intermediate bulk containers may comprise three or more intermediate bulk containers.

The output from the mixing station may be directed into a floccule accumulation station and slowly stirred to promote building of floccules before being discharged into the settlement station. The stirring in the floccule accumulation station may be performed at a speed less than that of the mixing in the mixing station. The stirring may include rotating a stirrer at between 1 and 100 revolutions per minute depending on the geometry of the stirrer and the capacity of the floccule accumulation station. Stirring of the water in the floccule accumulation station may be performed in an intermediate bulk container. The floccule accumulation station may comprise two or more intermediate bulk containers, with slow stirring being performed in each of the intermediate bulk containers. Residence time of the water in the floccule accumulation station may be at least 20 minutes.

Residence time of the water in the mixing station may be approximately 2 minutes.

Residence time of the water in the settlement station may be at least 1 hour.

The mixing station may be detachable from the settlement station and may be mounted on a vehicle to facilitate its deployment at various sites. The vehicle may be a powered vehicle, such as a utility truck, or may be an unpowered vehicle, such as a towable trailer. The floccule accumulation station may also be detachable from the settlement station and mounted on the vehicle. The vehicle may include a power source for powering the agitator(s) and/or stirrer(s).

The mixing may include rotating an agitator at between 1000 and 3000 revolutions per minute depending on the geometry of the agitator and the capacity of the mixing station.

A water pump may be associated with the mixing station for pumping water for treatment into the mixing station.

A coagulant dosing pump may be associated with the mixing station for injecting the coagulant into the water in the mixing station. The coagulant may comprise, for example, alum, ferric chloride or aluminium chlorohydrate.

Water output from the settlement station may be filtered. The filtering may be performed using, for example, a granular filter, such as a sand, zeolite or diatomaceous earth filter, or a paper-type cartridge filter.

Water output from the downstream end of the settlement station may be disinfected in a disinfection station. The disinfection may be performed using, for example, chlorine, sodium hypochlorite or hydrogen peroxide and or silver ion. Residence time of the water in the disinfection station may be around 20 minutes.

Water output from the downstream end of the settlement station may be pumped to a large storage reservoir.

In a fourth aspect, there is provided a water treatment method, comprising:

installing a first settlement station adjacent a source of water requiring treatment, the settlement station comprising at least one settling reservoir;

placing a transportable mixing station adjacent the settlement station;

hydraulically connecting the mixing station to the settlement station;

directing water from the source of water requiring treatment into the mixing station;

mixing coagulant into the water in the mixing station;

directing the water from mixing station into the settlement station and allowing contaminants in the water to settle therein;

disconnecting the mixing station from the settlement station; and

deploying the mixing station at another site.

The first settlement station may comprise a first plurality of intermediate bulk containers which may be hydraulically connected together in series, and contaminants in the water may be allowed to settle in the intermediate bulk containers in a clarifying sequence. The first settlement station may comprise a second plurality of intermediate bulk containers hydraulically connected together in series, the second plurality of intermediate bulk containers being in parallel to the first plurality of intermediate bulk containers, such that contaminants in the water are allowed to settle in each branch of the intermediate bulk containers in a clarifying sequence. The first plurality of intermediate bulk containers may comprise three or more intermediate bulk containers. The second plurality of intermediate bulk containers may comprise three or more intermediate bulk containers.

The output from the mixing station may be directed into a transportable floccule accumulation station and slowly stirred to promote building of floccules before being discharged into the settlement station. The stirring in the floccule accumulation station may be performed at a speed less than that of the mixing in the mixing station. The stirring may include rotating a stirrer at between 1 and 100 revolutions per minute depending on the geometry of the stirrer and the capacity of the floccule accumulation station. Stirring of the water in the floccule accumulation station may be performed in an intermediate bulk container. The floccule accumulation station may comprise two or more intermediate bulk containers, with slow stirring being performed in each of the intermediate bulk containers. Residence time of the water in the floccule accumulation station may be at least 20 minutes.

Residence time of the water in the settlement station may be at least 1 hour.

Residence time of the water in the mixing station may be approximately 20 minutes.

The mixing station may be mounted on a vehicle, which may be a powered vehicle, such as a utility truck, or may be an unpowered vehicle, such as a towable trailer. The vehicle may include a power source for powering the agitator(s) and/or stirrer(s). The flocculation station may also be mounted on the vehicle.

The mixing may include rotating an agitator at between 1000 and 3000 revolutions per minute depending on the geometry of the agitator and the capacity of the mixing station.

A water pump may be associated with the mixing station for pumping water for treatment into the mixing station.

A coagulant dosing pump may be associated with the mixing station for injecting coagulant into the water entering the mixing station. The coagulant may comprise, for example alum, ferric chloride or aluminium chlorohydrate.

Water output from the downstream end of the settlement station may be disinfected in a disinfection station. The water may be disinfected with any suitable disinfectant, for example, chlorine, sodium hypochlorite, hydrogen peroxide and/or silver ion. Residence time of the water in the disinfection station may be around 20 minutes

Water output from the downstream end of the settlement station may be pumped to a large storage reservoir.

A second said settlement station may be installed adjacent a second source of water requiring treatment, and the mixing station and flocculation station may be moved between the first and second settlement stations to facilitate treatment of the first and second water sources as demand requires.

In a fifth aspect, there is provided a water treatment system comprising:

at least one water treatment unit comprising:
one or more reservoirs for receiving water undergoing treatment in the system, each of the one or more reservoirs comprising an inlet for receiving water undergoing treatment and a first outlet for discharging the water,
at least one of the one or more reservoirs having a mixer associated therewith for mixing coagulant into the water,
at least one of the one or more reservoirs having a mixer associated therewith for promoting building of floccules in the water/coagulant mixture, and
at least one of the one or more reservoirs being configured for settling of the floccules therein,
wherein at least one of the one or more reservoirs is an intermediate bulk container (IBC).

The mixer for mixing coagulant into the water may take any form and may, for example, comprise: a rotatable shaft and at least one paddle mounted thereon; or the inlet being oriented or otherwise configured to cause water flowing into the reservoir to promote swirling of water in the reservoir. In some embodiments, mixing of coagulant and building of floccules may take place in the same reservoir. In such embodiments, the mixer for mixing coagulant into the water may be the same mixer as the mixer for promoting building of floccules. For example, in some embodiments, the mixer for mixing coagulant into the water may be configured to cease operating when a water level in the reservoir reaches a predetermined level, such as the reservoir being full, thereby causing movement of the water/coagulant mixture in the reservoir to slow down to promote the building of floccules. In other embodiments, the mixer for mixing coagulant into the water may be configured to more gently move the water/coagulant mixture in the reservoir when a water level in the reservoir reaches a predetermined level, such as the reservoir being full, to promote the building of floccules.

Each of the at least one reservoir in which settlement occurs may comprise a second outlet for discharging accumulated sludge from a lower region thereof.

In some embodiments, mixing of coagulant, building of floccules and settlement of floccules occurs in the same reservoir of the one or more reservoirs. In other embodiments, mixing of coagulant occurs in one or more of the one or more reservoirs, building of floccules occurs in a different one or more of the one or more reservoirs, and settlement of floccules occurs in a different one or more of the one or more reservoirs. In other embodiments, both mixing of coagulant and building of floccules occurs in one of the one or more reservoirs, and settlement of floccules occurs in a different one of the one or more reservoirs. In other embodiments, mixing of coagulant occurs in one of the one or more reservoirs, and both building of floccules and settlement of floccules occurs in a different one of the one or more reservoirs.

In embodiments where the mixer comprises a rotatable shaft and at least one paddle mounted thereon, the rotatable shaft may be mounted substantially vertically and substantially centrally in the associated reservoir, and the at least one paddle may be a single large paddle or a plurality of smaller paddles spaced along the shaft. The rotatable shaft may extend through a substantially central opening in the top of the associated reservoir. A guide collar, which may take the form of a boss, may be fixedly connected relative to the central opening for the shaft, the guide collar having a cylindrical opening extending therethrough that has a diameter corresponding to the diameter of the shaft, wherein the shaft extends through the cylindrical opening of the guide collar and rotates within the cylindrical opening of the guide collar in use.

Each of the one or more reservoirs configured for settling of floccules therein may be an IBC. Each of the one or more reservoirs in which building of floccules occurs may be an IBC. Each of the one or more reservoirs in which mixing of coagulant occurs may be an IBC.

Prior to any conversion required for use in the system, the IBC(s) may comprise a unitary body of one-piece construction, the body comprising a contiguous base, sidewalls and top. Any IBCs that are to have a mixer (of the type comprising a rotatable shaft and at least one paddle mounted thereon) installed may have at least one opening formed in the top, the relative sizes of the opening and the at least one paddle being such as to facilitate the at least one paddle being inserted into the IBC through the at least one opening. The at least one opening may be sealed after insertion of the at least one paddle into the IBC. The at least one opening may be sealed by a removeable closure. The at least one opening may comprise two openings at diametrically spaced apart locations in the top. In some embodiments, at least one opening may be formed in the sidewalls of the IBC to facilitate the at least one paddle being inserted into the reservoir. The at least one opening in the sidewalls may be sealed after insertion of the at least one paddle. The at least one opening in the sidewalls may be permanently sealed.

The rotatable shaft may be rotated by a motor and associated gearbox. The motor may comprise a variable speed drive. A support structure may extend across the top of the IBC to support the motor and gearbox. The motor may be powered by an electrical power supply, such as a generator (e.g., a petrol or diesel generator) or one or more electrochemical cells (e.g., one or more lead acid batteries). The power supply may be connected to the motor via an inverter. The inverter may step a voltage provided by the power supply up or down to match voltage requirements of the motor. The motor may be a 415 Volt motor. In embodiments comprising a plurality of the water treatment units, a single power supply may serve all of the motors. In embodiments comprising a plurality of the water treatment units, a single inverter may serve all of the motors.

The water treatment system may comprise a plurality of the water treatment units. The plurality of water treatment units may be configured for connection in parallel to a source of water for treatment by the system.

The water treatment system may comprise a controller for controlling operation of the water treatment unit(s). For example, the controller may control any one or more of, or all of: the rotational speed of the mixer; the operation of valves and/or one or more pumps controlling flow of water for treatment into, out of and/or through the water treatment unit(s); and the actuation of a coagulant dosing device for dosing coagulant into the reservoir(s).

A water pump may be associated with the water treatment unit(s) for pumping water for treatment into the reservoir(s).

A coagulant dosing pump may be associated with the water treatment unit(s) for dosing coagulant into the reservoir(s). The coagulant may comprise, for example, alum, ferric chloride or aluminium chlorohydrate.

At least one filtration station may be provided at the downstream end of the system for filtering treated water output from the water treatment unit(s). The filtration station may comprise a granular filter, such as a sand, zeolite or diatomaceous earth filter, or a paper-type cartridge filter. A single filtration station may serve one or more said water treatment unit.

At least one disinfectant dosing pump may be provided to inject disinfectant into treated water output from the water treatment unit(s). The disinfectant may comprise, for example, chlorine, sodium hypochlorite or hydrogen peroxide and/or silver ion. A reservoir for relatively clear water may be provided to receive treated water output from the water treatment unit(s) and the disinfectant may be injected into this reservoir. In other embodiments, the disinfectant may be dosed in-line.

A water pump may be provided to pump water output from the downstream end of the system to a large storage reservoir.

The system may be transportable and may, for example, be assembled in a shipping container or other housing and/or mounted on a vehicle to facilitate its deployment at various sites.

In a sixth aspect, there is provided a water treatment system comprising:

at least one water treatment unit comprising:
a reservoir for receiving water for treatment, the reservoir being an intermediate bulk container (IBC) and comprising an inlet for receiving water for treatment and a first outlet for discharging water that has been treated in the reservoir, and
a mixer associated with the reservoir for mixing coagulant into the water and thereafter for promoting building of floccules.

The mixer may take any form and may, for example, comprise: a rotatable shaft and at least one paddle mounted thereon; or the inlet being oriented or otherwise configured to cause water flowing into the reservoir to promote swirling of water in the reservoir. In some embodiments, the mixer may be configured to cease operating when a water level in the reservoir reaches a predetermined level, such as the reservoir being full, thereby causing movement of the water/coagulant mixture in the reservoir to slow down to promote the building of floccules. In other embodiments, the mixer may be configured to more gently move the water/coagulant mixture in the reservoir when a water level in the reservoir reaches a predetermined level, such as the reservoir being full, to promote the building of floccules. The reservoir may comprise a second outlet for discharging accumulated sludge from a lower region of the reservoir.

In embodiments where the mixer comprises a rotatable shaft and at least one paddle mounted thereon, the rotatable shaft may be mounted substantially vertically and substantially centrally in the reservoir, and the at least one paddle may be a single large paddle or a plurality of smaller paddles spaced along the shaft. The rotatable shaft may extend through a substantially central opening in the top of the reservoir. A guide collar, which may take the form of a boss, may be fixedly connected relative to the central opening for the shaft, the guide collar having a cylindrical opening extending therethrough that has a diameter corresponding to the diameter of the shaft, wherein the shaft extends through the cylindrical opening of the guide collar and rotates within the cylindrical opening of the guide collar in use.

Prior to conversion for use in the system, the IBC may comprise a unitary body of one-piece construction, the body comprising a contiguous base, sidewalls and top. The IBC may have at least one opening formed in the top, the relative sizes of the opening and the at least one paddle being such as to facilitate the at least one paddle being inserted into the reservoir through the at least one opening. The at least one opening may be sealed after insertion of the at least one paddle into the reservoir. The at least one opening may be sealed by a removeable closure. The at least one opening may comprise two openings at diametrically spaced apart locations in the top. In some embodiments, at least one opening may be formed in the sidewalls of the IBC to facilitate the at least one paddle being inserted into the reservoir. The at least one opening in the sidewalls may be sealed after insertion of the at least one paddle into the reservoir. The at least one opening in the sidewalls may be permanently sealed.

The rotatable shaft may be rotated by a motor and associated gearbox. The motor may comprise a variable speed drive. A support structure may extend across the top of the reservoir to support the motor and gearbox. The motor may be powered by an electrical power supply, such as a generator (e.g., a petrol or diesel generator) or one or more electrochemical cells (e.g., one or more lead acid batteries). The power supply may be connected to the motor via an inverter. The inverter may step a voltage provided by the power supply up or down to match voltage requirements of the motor. The motor may be a 415 Volt motor. In embodiments comprising a plurality of the water treatment units, a single power supply may serve all of the motors. In embodiments comprising a plurality of the water treatment units, a single inverter may serve all of the motors.

The water treatment system may comprise a plurality of the water treatment units. The plurality of water treatment units may be configured for connection in parallel to a source of water for treatment by the system.

The water treatment system may comprise a controller for controlling operation of the water treatment unit(s). For example, the controller may control any one or more of, or all of: the rotational speed of the mixer; the operation of valves and/or one or more pumps controlling flow of water for treatment into, out of and/or through the water treatment unit(s); and the actuation of a coagulant dosing device for dosing coagulant into the reservoir(s).

A water pump may be associated with the water treatment unit(s) for pumping water for treatment into the reservoir(s).

A coagulant dosing pump may be associated with the water treatment unit(s) for dosing coagulant into the reservoir(s). The coagulant may comprise, for example, alum, ferric chloride or aluminium chlorohydrate.

At least one filtration station may be provided at the downstream end of the system for filtering treated water decanted from the reservoir(s) via the first outlet. The filtration station may comprise a granular filter, such as a sand, zeolite or diatomaceous earth filter, or a paper-type cartridge filter. A single filtration station may serve one or more said water treatment unit.

At least one disinfectant dosing pump may be provided to inject disinfectant into treated water decanted from the first outlet of the reservoir(s). The disinfectant may comprise, for example, chlorine, sodium hypochlorite or hydrogen peroxide and/or silver ion. A reservoir for relatively clear water may be provided to receive treated water decanted from the first outlet of the reservoir(s) and the disinfectant may be injected into this reservoir. In other embodiments, the disinfectant may be dosed in-line.

A water pump may be provided to pump water output from the downstream end of the system to a large storage reservoir.

The system may be transportable and may, for example, be assembled in a shipping container or other housing and/or mounted on a vehicle to facilitate its deployment at various sites.

In another aspect, there is provided a method of water treatment corresponding to the system of the fifth or sixth aspect set out above.

### BRIEF DESCRIPTION OF DRAWINGS

An embodiment of the presently disclosed water treatment system will now be described, by way of example only, with reference to the accompanying drawings, in which:

FIG. 1 is a schematic view of a first embodiment of a water treatment system embodying principles disclosed herein;

FIG. 2 is a schematic view of a mobile mixing/floccule accumulation station of the water treatment system of FIG. 1;

FIG. 3 is a schematic view of an embodiment of a water treatment unit for an alternative water treatment system embodiment;

FIG. 4 is a view of the water treatment unit of FIG. 3 with part of its side cut away to allow internal components to be seen; and

FIG. 5 is a schematic view of an embodiment of a water treatment system including the water treatment unit of FIGS. 3 and 4.

### DESCRIPTION OF EMBODIMENTS

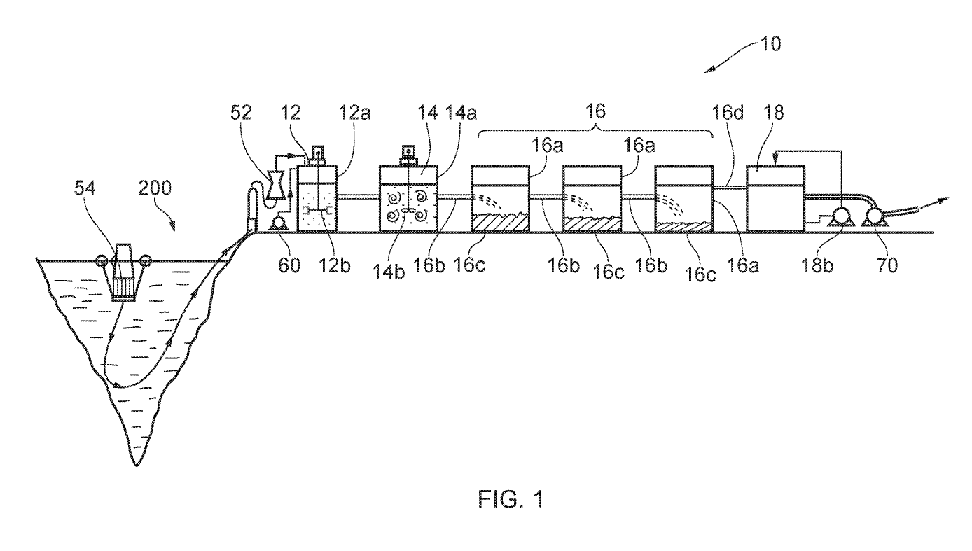

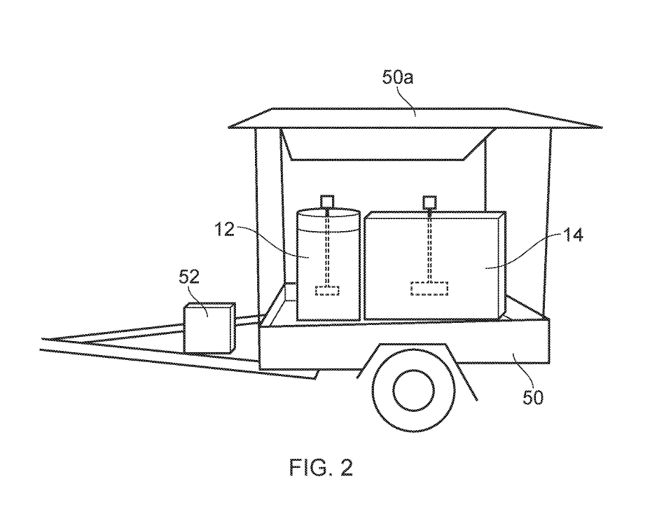

Referring to FIGS. 1 and 2, there is shown a water treatment system 10. The system 10 comprises a hydraulic circuit including a rapid mixing station 12 at an upstream end, a floccule accumulation station 14 receiving output from the mixing station, and a settlement station 16 receiving output from the floccule accumulation station.

The mixing station 12 includes a first reservoir 12a for receiving water for treatment from a source, such as a dam, river, bore or well 200. An agitator 12b is provided in the first reservoir for flash mixing coagulant into the water in the first reservoir 12a. The agitator 12b is powered by a motor and is adapted to rotate at a speed of around 1400 revolutions per minute depending on the geometry of the agitator 12b and the capacity of the reservoir 12a.

The floccule accumulation station 14 comprises a second reservoir, in the form of an IBC 14a, for receiving output from the first reservoir 12a of the mixing station 12. A slow speed stirrer 14b extends into the second reservoir 14a and is configured to promote building of floccules as the coagulant causes contaminant particles in the water to clump together. The slow speed stirrer 14b rotates at approximately 30 revolutions per minute depending on the geometry of the stirrer 14b and the capacity of the reservoir 14a.

The settlement station 16 is modular and comprises a plurality of intermediate bulk containers (IBCs) 16a hydraulically connected together in series by conduits 16b extending therebetween. The conduits have a minimum internal diameter of around 100 mm. The large diameter of the conduits 16b together with a deliberately relatively slow flow rate through the settlement station 16 inhibits the floccules from being broken up and allows them to settle to the base of the IBCs 16a as sludge for removal through an outlet 16c at the base of each IBC 16a.

A downstream most of the IBCs 16a has an upper outlet 16d for discharging the relatively clear treated water to a disinfecting station 18, which comprises a reservoir in the form of an IBC 18a. The outlet 16d is located near the top of the downstream most IBC 16a, above the level of the conduits 16b. A disinfectant dosing pump 18b is provided to inject disinfectant, such as chlorine, sodium hypochlorite or hydrogen peroxide and/or silver ion into the reservoir 18.

As shown in FIG. 2, the mixing station 12 and floccule accumulation station 14 are detachable from the settlement station 16 and mounted on a vehicle in the form of a towable trailer 50. For ease of understanding, the trailer 50 is not shown in the schematic diagram of FIG. 1. The trailer 50 includes a power supply, in the form of a petrol or diesel powered generator 52, for powering the agitator 12b, stirrer 14b and various pumps of the water treatment system 10. In some embodiments, a water pump, such as a sump pump 54, is carried on the trailer 50 for pumping water from the source 100 into the first reservoir 12a for treatment. In other embodiments, a pump may be permanently installed near the water source 100 and connected to the first reservoir 12a when required. A coagulant dosing pump 60 is also carried on the trailer 50 for injecting coagulant, such as alum, ferric chloride or aluminium chlorohydrate, into the first reservoir 12a. The trailer 50 has a roof 50a for protecting the system components carried thereon from the weather.

A water pump 70 is provided to pump water from the reservoir 18 to a large storage reservoir.

The IBCs used in the system 10 may have a capacity of 1000 L to 1500 L. The IBCs may have a galvanised steel cage therearound, particularly in cases where the IBC is blow moulded.

The capacity of the mixing station 12, floccule accumulation station 14, settlement station 16 and disinfecting station 18 can be scaled up to treat up to around 20 m³ of water per hour or down to treat as little as around 1 m³ of water per hour whilst still maintaining desired residence times in the various system components. For example, scaling up or down of the settlement station 16, which has the largest capacity of the various stations in the system 10, can be easily accomplished by adjusting the number of IBCs 16a. The desired residence time of the water in the rapid mixing station 12 is approximately 2 minutes. The desired residence time of the water in the floccule accumulation station is at least 20 minutes. The desired residence time of the water in the settlement station 16 is at least one hour. The desired residence time of the water in the disinfection station 18 is approximately 20 minutes.

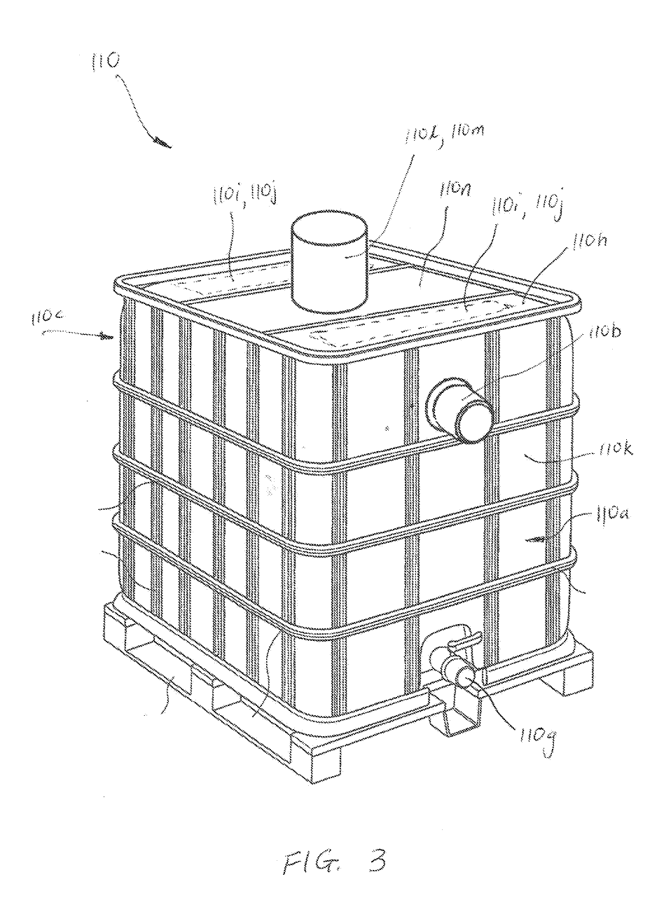

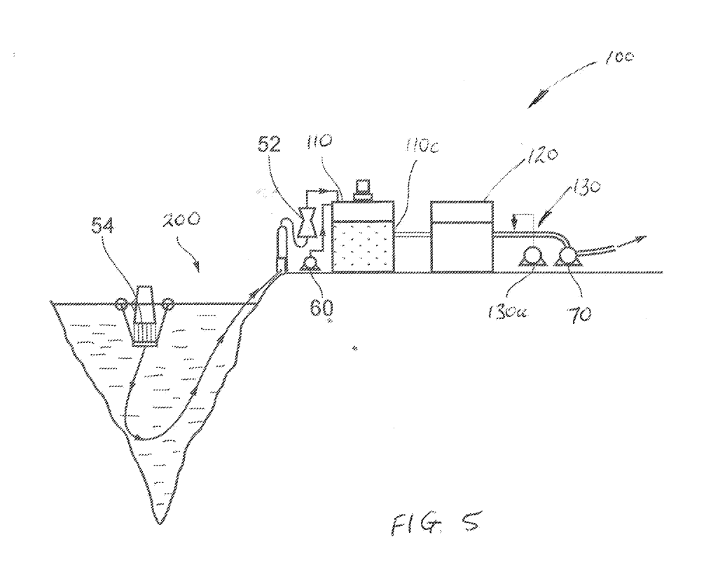

An alternative embodiment of a water treatment system 100 will now be described with reference to FIGS. 3 to 5. The water treatment system 100 comprises one or more water treatment unit(s) 110, a filtration station 120 and a disinfection station 130. In embodiments comprising a plurality of water treatment units 110, the plurality of water treatment units 110 are connected in parallel to a source of water for treatment.

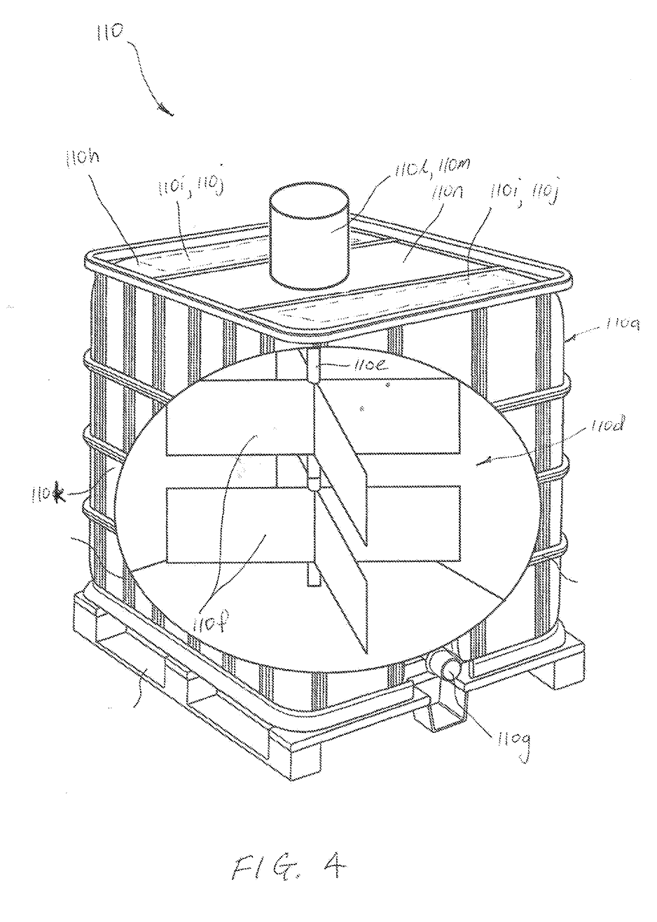

As shown in FIGS. 3 and 4, the water treatment unit 110 comprises a reservoir 110a in the form of an IBC for receiving water for treatment. The reservoir 110a comprises an inlet 110b for receiving the water for treatment and an upper outlet 110c, located diametrically opposite the inlet 110b, for discharging water that has been treated in the reservoir. A mixer 110d comprising a rotatable shaft 110e with two paddles 110f mounted thereon is mounted in the reservoir 110a for mixing coagulant into water contained therein and thereafter for promoting building of floccules.

In some embodiments, the mixer 110d is configured to rotate more slowly when a water level in the reservoir 110a reaches a predetermined level, which may be when the reservoir is full or may be a level below the maximum capacity of the reservoir, or after mixing has been performed for a predetermined period of time. Slow rotation of the mixer 110d causes the water/coagulant mixture in the reservoir 110a to move more gently and promotes the building of floccules. In other embodiments, the mixer 110d is configured to cease operating when the reservoir 110a reaches a predetermined level, which may be when the reservoir is full or may be a level below the maximum capacity of the reservoir, or when mixing has been performed for a predetermined period of time. Ceasing of operation of the mixer 110d causes movement of the water/coagulant mixture in the reservoir 110a to slow down to promote the building of floccules. In either case, the reservoir 110a comprises a lower outlet 110g for discharging settled material/accumulated sludge from the bottom of the reservoir.

The rotatable shaft 110e is mounted substantially vertically and substantially centrally in the reservoir 110a, and the paddles 110f are spaced along the shaft 110e. The shaft 110e extends through a substantially central opening in the top 110h of the reservoir 110a. A guide collar, in form of a boss, is fixedly connected relative to the central opening in the top 110h, the guide collar having a cylindrical opening extending therethrough that has a diameter corresponding to the diameter of the shaft 110e. The shaft 110e extends through the cylindrical opening of the guide collar and rotates within the cylindrical opening of the guide collar in use.

The IBCs used in the system 100 may have a capacity of 1000 L to 1500 L. The IBCs may have a galvanised steel cage therearound, particularly in cases where the IBC is blow moulded. Prior to conversion for use in the system, an IBC for forming the reservoir 110a will generally comprise a unitary body of one-piece construction, the body comprising a contiguous base, sidewalls and top. During conversion, the IBC has two openings 110i formed in the top 110h at diametrically spaced apart locations. The relative sizes of the openings 110i and the paddles 110f are such as to facilitate the paddles being inserted into the reservoir 110a through the openings 110i. The openings 110i are sealed with a removable closure 110j after insertion of the paddles 110f into the reservoir. In some embodiments of the water treatment unit 110, especially embodiments where the shaft 110e has three or more paddles 110f mounted thereon, at least one opening may be formed in the sidewalls 110k of the IBC to facilitate one or more paddles 110f being inserted into the reservoir 110a therethrough. In such embodiments, the opening(s) in the sidewalls 110k are sealed, preferably permanently, after insertion of the paddle(s) therethrough.

The shaft 110e is rotated by a 415 Volt motor 110l and associated gearbox 110m. The motor 110l comprises a variable speed drive. A support structure, in the form of a bridge 110n, extends across the top of the reservoir 110a to support the motor 110l and gearbox 110m. The motor 110l is powered by an electrical power supply in the form of a petrol or diesel generator (not shown). The power supply is connected to the motor 110l via an inverter (not shown). The inverter steps a voltage provided by the power supply up or down to match voltage requirements of the motor 110l. In embodiments of the system 100 comprising a plurality of water treatment units 110, a single power supply and single inverter serve all of the motors.

A water pump 54 is associated with the water treatment unit(s) 110 for pumping water for treatment into the reservoir(s) 110a.

A coagulant dosing pump 60 is associated with the water treatment unit(s) 110 for dosing coagulant into the reservoir(s) 110a. The coagulant may comprise, for example, alum, ferric chloride or aluminium chlorohydrate.

Filtration station 120 is provided at the downstream end of the system 100 for filtering treated water decanted from the reservoir(s) 110a via the upper outlet(s) 110c. The filtration station 120 comprises a granular filter, such as a sand, zeolite or diatomaceous earth filter, or a paper-type cartridge filter. A single filtration station 120 may serve one or more water treatment unit 110.

Disinfecting station 130 is provided downstream of the filtration station 120 to receive filtered water therefrom. The disinfection station 130 comprises a disinfectant pump 130a for in-line dosing of disinfectant into a pipe that receives filtered water from filtration station 120. Any suitable disinfectant may be used, such as chlorine, sodium hypochlorite, hydrogen peroxide and/or silver ion.

A water pump 70 is provided to pump water output from the downstream end of the system 100 to a large storage reservoir. Alternatively, water treated in the system 100 may be pumped, or flow under the influence of gravity, to a plurality of IBCs for storage.

The water treatment system 100 comprises a controller (not shown) for controlling operation of the water treatment unit(s) 110 and other components of the system 100. For example, the controller controls: the motor 110l to control the rotational speed of the mixer 110d; the operation of valves controlling flow of water for treatment into, out of and/or through the water treatment unit(s) 110; and the actuation of the coagulant and disinfectant dosing pumps 60, 130a. The controller may also control actuation of pump 54 and 70.

The system 100 is transportable and may, for example, be assembled in a shipping container or other housing and/or mounted on a vehicle to facilitate its deployment.

It will be appreciated that the above described systems and methods provide a number of advantages over the prior art. For example, the systems 10, 100 are relatively inexpensive, quick and easy to install due to their modular nature and use of IBCs, which are readily available at a low cost. Accordingly, systems 10, 100 are well suited for use in agricultural applications for treatment of water for stock, such as on feedlots, poultry farms, in piggeries and chicken sheds, as well as in remote communities or emergency situations. The systems 10, 100 are also easily scalable in capacity, which can be difficult in prior art systems where large capital cost reservoirs are utilised, especially for the settlement tank(s). The transportability of the mixing 12 and floccule accumulation 14 stations of system 10, due to their disengageability from the settlement station 16 and mounting on the trailer 50, also advantageously allows one mixing/floccule accumulation unit 12, 14 to be moved between several settlement stations 16 instead of requiring each settlement station to have its own dedicated mixing 12 and floccule accumulation 14 stations as is the case in the prior art. The transportability of the entire system 100 makes it advantageous for applications where there is no need for a long term water remediation solution, as the whole system 100 can be easily redeployed or moved into storage when its remediation task is completed.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive. Examples of possible variations and/or modifications include, but are not limited to:
the floccule accumulation station 14 of system 10 comprising two or more reservoirs 14a, each having an associated slow speed stirrer;
the settlement station 16 of system 10 comprising more than three IBCs 16a hydraulically connected together in series;
the settlement station 16 of system 10 comprising a second plurality of IBCs hydraulically connected together in series, the second plurality of IBCs being in parallel to the first plurality of IBCs;
the reservoir 12a of the mixing station 12 may be an IBC;
the vehicle 50 of system 10 being a utility truck or other powered vehicle;
a filtration station, similar to filtration station 120 of system 100, may be provided at a downstream end of system 10, either between the downstream end of the settlement station 16 and the disinfection station 18 or downstream of the disinfection station 18;
system 10 being housed in a shipping container or other housing;
instead of mixer 110d, system 100 may comprise a mixer that comprises the inlet 110b being oriented or otherwise configured to cause water flowing into the reservoir 110a to promote swirling of water in the reservoir;
more than two paddles 110f may be spaced along and mounted on the shaft 110e, or a single larger paddle 110f may be used instead of multiple paddles;
the power supply may alternatively comprise one or more electrochemical cells (e.g., one or more lead acid batteries);
disinfectant may be dosed in-line downstream of the settlement station 16 in system 10 and the tank of disinfecting station 18 may be omitted; and/or
the coagulant dosing pump 60 may dose coagulant in-line into a conduit/pipe through which water flows into the mixing station 12 of system 10 or through which water flows into the water treatment units(s) 110 of system 100.

1. A water treatment system comprising:
at least one water treatment unit comprising:
one or more reservoirs for receiving water undergoing treatment in the system, each of the one or more reservoirs comprising an inlet for receiving water undergoing treatment and a first outlet for discharging the water,
at least one of the one or more reservoirs having a mixer associated therewith for mixing coagulant into the water,
at least one of the one or more reservoirs having a mixer associated therewith for promoting building of floccules in the water/coagulant mixture, and
at least one of the one or more reservoirs being configured for settling of the floccules therein,
wherein at least one of the one or more reservoirs is an intermediate bulk container (IBC).

2. A system according to claim 1, comprising from one to a plurality of reservoirs downstream of the at least one reservoir that has the mixer associated therewith for promoting building of floccules.

3. A system according to claim 2, wherein at least one of said from one to a plurality of reservoirs are IBCs.

4. A system according to claim 1, wherein the mixing of coagulant and building of floccules occur in the same reservoir.

5. A system according to claim 4, wherein the mixer for mixing coagulant into the water is the same mixer as the mixer for promoting building of floccules.

6. A system according to claim 1, wherein the building and settlement of floccules occur in the same reservoir.

7. A system according to claim 1, wherein each of the at least one reservoir in which settlement occurs comprises a second outlet for discharging settled material from a lower region thereof.

8. A system according to claim 1, wherein the mixer for promoting building of floccules comprises a rotatable shaft and at least one paddle mounted thereon.

9. A system according to claim 8, wherein the rotatable shaft is mounted substantially vertically and substantially centrally in the associated reservoir, the rotatable shaft extending through a substantially central opening in the top of the associated reservoir, wherein a guide collar is fixedly connected relative to the central opening for the shaft, the guide collar having a cylindrical opening extending therethrough that has a diameter corresponding to the diameter of the shaft, wherein the shaft extends through the cylindrical opening of the guide collar and rotates within the cylindrical opening of the guide collar in use.

10. A system according to claim 1, wherein each of the one or more reservoirs configured for settling of floccules therein is an IBC.

11. A system according to claim 1, wherein each of the one or more reservoirs in which building of floccules occurs is an IBC.

12. A system according to claim 1, wherein each of the one or more reservoirs in which mixing of coagulant occurs is an IBC.

13. A system according to claim 11, wherein:
each of the IBCs in which building of floccules occurs comprises at least one opening formed in its top, and
the mixer for promoting building of floccules in the water/coagulant mixture comprises one or more paddles, the one or more paddles being sized to fit through the at least one opening to facilitate installation of the one or more paddles in each of the IBCs in which building of floccules occurs.

14. A system according to claim 13, wherein the at least one opening is sealed by a removeable closure.

15. A system according to claim 11, comprising a motor and associated gearbox for rotating the mixer for promoting building of floccules in the water/coagulant mixture.

16. A system according to claim 15, wherein the motor comprises a variable speed drive.

17. A system according to claim 15, comprising a support structure to support the motor and gearbox, the support structure extending across the top of the IBC associated with the motor and gearbox.

18. A system according to claim 1, comprising a plurality of the water treatment units for connection in parallel to a source of water for treatment by the system.

19. A system according to claim 1, comprising a controller for controlling operation of the at least one water treatment unit.

20. A system according to claim 1, comprising a water pump associated with the at least one water treatment unit for pumping water for treatment into an upstream end thereof.

21. A system according to claim 1, comprising a coagulant dosing pump associated with the at least one water treatment unit for dosing coagulant into the one or more reservoir in which coagulant is mixed into the water.

22. A system according to claim 1, comprising at least one filtration station at the downstream end thereof for filtering treated water output from the water treatment unit.

23. A system according to claim 1, comprising at least one disinfectant dosing pump to inject disinfectant into treated water output from the at least one water treatment unit.
